(19) United States
(12) Patent Application Publication
(10) Pub. No.: US 2010/0066036 A1
(43) Pub. Date: Mar. 18, 2010

(54) COMPRESSIVE COMPOSITE SEALS FOR SOFC APPLICATIONS

(75) Inventors: Terry A. Cruse, Lisle, IL (US); Michael Krumpelt, Naperville, IL (US); Brian J. Ingram, Chicago, IL (US)

Correspondence Address: JOAN PENNINGTON, 535 NORTH MICHIGAN AVENUE, UNIT 1804, CHICAGO, IL, 60611, US

(73) Assignee: UCHICAGO ARGONNE, LLC, Chicago, IL (US)

(21) Appl. No.: 12/429,048

(22) Filed: Apr. 23, 2009

Related U.S. Application Data
(60) Provisional application No. 61/097,994, filed on Sep. 18, 2008.

(51) Int. Cl. F16J 15/02

(52) U.S. Cl. 277/654

(57) ABSTRACT

Compressive composite seals for solid oxide fuel cell applications are provided. A compressive composite seal structure includes a glass phase to provide a gas tight seal, a reinforcing secondary phase to provide mechanical stability, and a compressive core. The compressive core is filled with an inert gas or air, providing a degree of compressibility, or alternatively is filled with a selected material to provide a more specific degree of compressibility and strength, such as a lower melting point glass. The compressive composite seal structure maintains an effective seal during the operating conditions of the SOFC. The self healing glass phase with the reinforcing secondary phase providing mechanical stability provides an elastic response at high temperature, effectively reduces crack propagation and if the temperature or pressure goes too high, the seal remains reliable and effective.

This application claims the benefit of U.S. Provisional Application No. 61/097,994 filed on Sep. 18, 2008.

### CONTRACTUAL ORIGIN OF THE INVENTION

The United States Government has rights in this invention pursuant to Contract No. W-31-109-ENG-38 between the United States Government and The University of Chicago and/or pursuant to Contract No. DE-AC02-06CH11357 between the United States Government and UChicago Argonne, LLC representing Argonne National Laboratory.

### FIELD OF THE INVENTION

The present invention relates to solid oxide fuel cells (SOFCs), and more particularly, relates to improved compressive composite seals for solid oxide fuel cell (SOFC) and other applications, for example, that require a high temperature seal with some elastic properties.

### DESCRIPTION OF THE RELATED ART

Solid oxide fuel cells (SOFCs) are high temperature, for example, 500-1000° C., electrochemical devices that convert the chemical energy of gaseous fuels (hydrogen, carbon monoxide, reformed hydrocarbons or alcohol mixtures) directly into electricity. The electrolyte, for example, yttria-stabilized zirconia, is a thin gas impermeable membrane that is usually supported on a planar porous anode. The fuel electrode, or anode, normally consists of a partially sintered mixture of nickel and electrolyte particles. The oxygen electrode, or cathode, is typically made of a porous perovskite material, such as an alkaline earth-doped LaMnO₃, LaFeO₃, LaCoO₃, or mixtures thereof.

Solid Oxide Fuel Cells show promise as electrical power sources for many applications, ranging from large stationary power plants to auxiliary power units for vehicles. This type of fuel cell has been demonstrated to have a high energy density, over 1 W/cm² in small single cells. Moreover, SOFCs are not limited to hydrogen as a fuel. Carbon monoxide, methane, alcohols, light hydrocarbons, and distillate fuels have been shown to reform directly on the SOFC anode, thereby greatly reducing the complexity of the pre-reformer.

Oxygen from air is reduced near the cathode/electrolyte interface forming oxygen ions. These ions diffuse through the electrolyte and combine with the fuel at the electrolyte/anode interface forming water and carbon oxides as exhaust and releasing electrons. The diffusion of oxygen ions through the electrolyte and the flow of electrons through the electrodes generate useful DC electricity.

The SOFC can also be reversed to produce hydrogen from steam in a high-temperature electrolysis mode. Steam is introduced at the fuel electrode and an electrical potential is applied across the cell. Steam is converted into hydrogen by reducing the oxygen from the water molecule into negative ions and hydrogen exhausts out of the cell as product. The oxygen ions diffuse through the electrolyte to the oxygen electrode, where the ions are reoxidized and liberated as oxygen gas byproduct.

To increase power output SOFC cells, each typically producing 0.7-1.0 V, are stacked in electrical series. A stack consists of cells; bipolar plates that electrically connect adjacent cells and separate fuel and air gases; flow fields to disperse gases along the plane of the cathode and anode; gas manifolds to distribute fuel and air to the perimeter of each cell in the stack; and seals around the perimeter of the cells to prevent mixing of fuel and air, and electrically insulating one side of the individual cell from the other.

One of the major issues in building planar SOFC stacks is the development and application of seals. State-of-the-art SOFC stacks are commonly manufactured as separate components, which are assembled together during the stacking process. Seals are used to join and close off the open perimeters of the components. The placement and number of seals varies according to the stack design. In general, a seal is needed between the electrolyte and the bipolar plate, around the perimeter of the anode to contain the fuel, and a seal is needed to connect each cell to the fuel manifold. It is not necessary to completely seal the cathode or air compartment except in regions adjacent to fuel flow. If a seal is electrically conductive, it cannot be applied in areas that would short-circuit the cells. Major classifications of seals include rigid bond seals, mechanical seals, and wet seals. Sealing materials most commonly used include glasses, cements, brazes, and gaskets.

Various sealing arrangements are known, for example, ceramic, glass, or glass ceramic seals have been used to assemble their co-flow SOFC stack. Also copper, nickel and silver paint or foil, and mica gaskets have been used to seal various layers together. Perimeter spacer seals have been used consisting of laminated layers of bipolar plate alloy, and copper, nickel or mica.

Several SOFC developers have formulated glass or glass ceramic materials to function as seals. The thermal expansion coefficients of rigid seals need to match those of the electrolyte and bipolar plate. The sealant must also be stable in oxidizing and reducing conditions, and it must be compliant enough to fill in gaps, but rigid enough to stop viscous flow during operation. Some of the problems that occur with using glass seals; they tend to react with other fuel cell materials over time, are subject to cracking on repeated or rapid heating cycles, or have to low a viscosity and readily flow from the sealing area.

Metal brazes can be used to a limited extent for sealing where short-circuiting is not a concern. Most brazes used involve silver-copper or nickel alloys. Brazes using silver are expensive, but seal at low temperatures. The nickel type brazes often must be heated over 1000° C. to seal, which adds to the cost and time of assembling a stack. Non-conductive glasses or gaskets are often needed where parts must be electrically insulated.

Mica gaskets have been used by some SOFC developers because they are compliant and allow sliding to tolerate thermal expansion mismatch. The gaskets can deform to fill in gaps due to the unevenness of ceramic cells with uniform pressure. However, they require the application of constant pressure to make a seal and offer little spring back if pressure is released. An adhesive, such as a sealing glass, is required to seal the gasket face to the face of the component.

A principal object of the present invention is to provide an improved solid oxide fuel cell seal.

Other important objects of the present invention are to provide such improved compressive composite seals for solid oxide fuel cell applications substantially without negative effect and that overcome some of the disadvantages of known arrangements.

### SUMMARY OF THE INVENTION

In brief, compressive composite seals for solid oxide fuel cell applications are provided. A compressive composite seal structure includes a glass phase to provide a gas tight seal, and a reinforcing secondary phase to provide mechanical stability. The glass phase and the reinforcing secondary phase of the compressive composite seal structure are shaped, for example, as a layered or rolled structure with a compressive core.

In accordance with features of the invention, the glass phase is a self healing glass that does not crystallize (or devitrify) over time and has sufficiently low viscosity and surface tension characteristics that if a crack occurs on thermal cycling the crack heals at operating temperature. The reinforcing secondary phase keeps the glass phase in place and provides predefined mechanical properties including elasticity. The self healing glass phase with the reinforcing secondary phase providing mechanical stability provides an elastic response at high temperature.

In accordance with features of the invention, the glass phase is selected to provide a good seal to the desired SOFC components. The compressive composite seal structure maintains an effective seal during all possible operating conditions of the SOFC. The compressive composite seal structure substantially allows the glass phase to effectively heal if a crack occurred during thermal cycling, with support provided by the reinforcing secondary phase. The reinforcing secondary phase effectively reduces crack propagation and provides mechanical support for the glass phase, so that if the temperature or pressure goes too high, the seal remains reliable and effective. The second phase is, for example, a crystalline ceramic, such as zirconia with 3% yttria.

In accordance with features of the invention, the compressive core is filled with an inert gas or air, selectively providing a degree of compressibility to this structure. The core alternatively is filled with a selected material to provide a more specific degree of compressibility and strength, such as a lower melting point glass.

In accordance with features of the invention, the novel structure and materials characteristics produce a unique and superior seal. Materials can advantageously be selected with different thermal expansion coefficients to take advantage of residual stresses further enhancing the properties of the seal.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 illustrates a composite seal structure in accordance with a preferred embodiment;

FIG. 2 illustrates an alternative composite seal structure in accordance with a preferred embodiment;

FIG. 3 illustrates another alternative composite seal structure in accordance with a preferred embodiment;

FIG. 4 illustrates a further alternative composite seal structure in accordance with a preferred embodiment;

### DETAILED DESCRIPTION OF THE PREFERRED EMBODIMENTS

In accordance with features of the invention, a compressive composite seal structure includes a glass phase to provide a gas tight seal, and a reinforcing secondary phase to provide mechanical stability. The glass phase and the crystalline ceramic phase of the compressive composite seal structure are shaped as a layered or rolled structure with a compressive core. The compressive composite seal structure maintains an effective seal with the glass phase during all possible operating conditions of the SOFC. This glass phase of the compressive composite seal structure substantially allows the glass to effectively heal if a crack occurred during thermal cycling, providing support to the reinforcing secondary phase. The reinforcing secondary phase reduces crack propagation and provides mechanical support for the glass phase, so that if the temperature or pressure goes too high, the seal remains effective.

In accordance with features of the invention, the glass phase is a self healing glass that does not crystallize (or devitrify) over time and has sufficiently low viscosity and surface tension characteristics that if it cracks on thermal cycling the crack will “heal” at operating temperature. The reinforcing secondary phase keeps the glass in place and provides mechanical properties including elasticity. The self healing glass phase with the reinforcing secondary phase providing mechanical stability provides an elastic response at high temperature.

In accordance with features of the invention, the novel structure and materials characteristics produce a unique and superior seal. Materials advantageously are selected with different thermal expansion coefficients to take advantage of residual stresses further enhancing the properties of the seal. The compressive core is filled with an inert gas or air, selectively providing a degree of compressibility to this structure. Alternatively the core is a selected material to provide a more specific degree of compressibility and strength, such as a lower melting point glass.

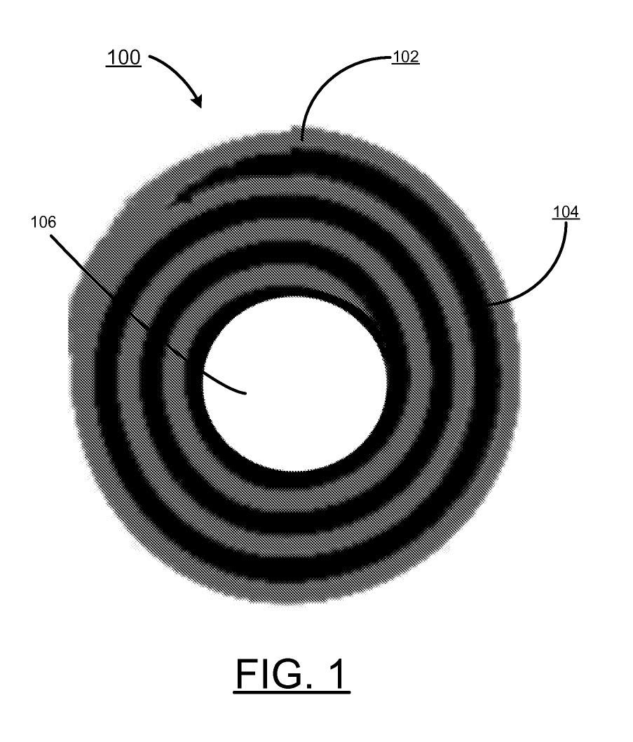

Having reference now to the drawings, in FIG. 1, there is shown a composite seal structure generally designated by the reference character 100 in accordance with the preferred embodiment. Composite seal structure 100 is a compressive composite seal structure including a glass phase generally designated by the reference character 102, a reinforcing secondary phase generally designated by the reference character 104 and a core 106.

The glass phase 102 is selected to provide and maintain an effective seal with a SOFC (not shown) during all possible operating conditions of the SOFC. The glass phase 102 is a self healing glass that does not crystallize or devitrify over time and has sufficiently low viscosity and surface tension characteristics that if it cracks on thermal cycling the crack heals at operating temperature. The reinforcing secondary or second phase 104 is, for example, a crystalline ceramic, such as zirconia with 3% yttria. A metal might also be used with modification to form the reinforcing secondary or second phase 104, particularly for other applications for high temperature seals than a SOFC.

The core 106 is a hollow core, for example, filled with an inert gas or air, analogous to an automotive tire providing a degree of compressibility to this seal structure 100. Alternatively the core 106 is filled with a selected material, for example, to provide a more specific degree of compressibility and strength, such as a lower melting point glass.

The glass phase 102 and the crystalline ceramic phase 104 of the compressive composite seal structure 100 are shaped, for example, as a multi-layer tape casting and rolled around a combustible filament having a control core diameter for compressive core 106.

The compressive composite seal structure 100 maintains an effective seal with the glass phase 102 provided in a multi-layer tape casting with the second phase 104 that substantially allows the glass to effectively heal if a crack occurred during thermal cycling, providing containment of the glass phase 102 with the reinforcing secondary phase 104. The reinforcing secondary phase 104 provides multi-layer protection, reducing crack propagation and providing mechanical support for the glass phase 102. The compressive composite seal structure 100 maintains an effective seal if the temperature or pressure goes too high, the seal remains in place and effective.

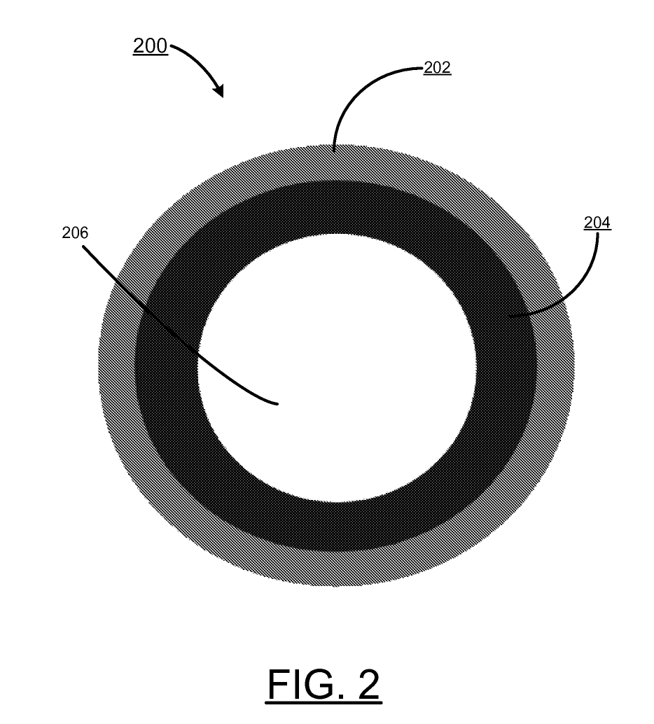

Referring now to FIG. 2, there is shown a composite seal structure generally designated by the reference character 200 in accordance with the preferred embodiment. Composite seal structure 200 is a compressive composite seal structure including a glass phase generally designated by the reference character 202, a reinforcing secondary phase generally designated by the reference character 204 and a core 206.

The glass phase 202 is a single layer or coating that is selected to provide and maintain an effective seal with a SOFC (not shown) during all possible operating conditions of the SOFC. The glass phase 202 is a self healing glass that does not crystallize or devitrify over time and has sufficiently low viscosity and surface tension characteristics that if it cracks on thermal cycling the crack heals at operating temperature. The reinforcing secondary or second phase 204 is, for example, a layer of a crystalline ceramic, such as zirconia with 3% yttria. A metal might also be used with modification to form the reinforcing secondary or second phase 204, particularly for other applications for high temperature seals than a SOFC.

The core 206 is a hollow core, for example, filled with an inert gas or air, analogous to an automotive tire providing a degree of compressibility to this seal structure 200. Alternatively the core 206 is filled with a selected material, for example, to provide a more specific degree of compressibility and strength, such as a lower melting point glass.

The glass phase 202 and the crystalline ceramic phase 204 of the compressive composite seal structure 200 are formed, for example, by wrapping tapes defining glass phase 202 and reinforcing secondary or second phase 204 around a combustible filament having a control core diameter for compressive core 206. Alternatively, a dip coating of a combustible filament having a control core diameter for compressive core 206 forms each of the glass phase 202 and the crystalline ceramic phase 204 of the compressive composite seal structure 200. With the compressive composite seal structure 200, it is more difficult to control thicknesses as precisely as with the compressive composite seal structure 100.

The compressive composite seal structure 200 maintains an effective seal with the glass phase 202 provided with the second phase 204 that substantially allows the glass to effectively heal if a crack occurred during thermal cycling, providing containment of the glass phase 202 with the reinforcing secondary phase 204. The reinforcing secondary phase 204 reduces crack propagation and provides mechanical support for the glass phase 202. The compressive composite seal structure 200 maintains an effective seal if the temperature or pressure goes too high, the seal remains in place and effective.

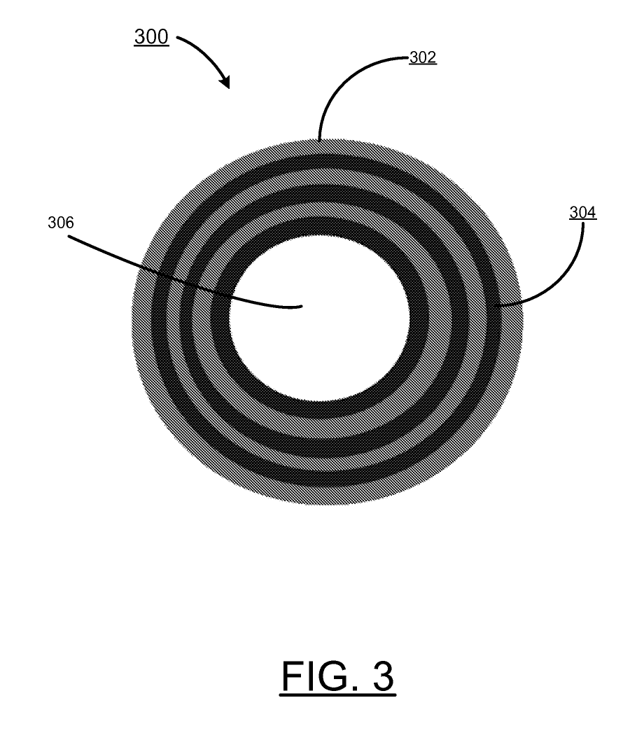

Referring now to FIG. 3, there is shown a composite seal structure generally designated by the reference character 300 in accordance with the preferred embodiment. Composite seal structure 300 is a compressive composite seal structure including a glass phase generally designated by the reference character 302, a reinforcing secondary phase generally designated by the reference character 304 and a core 306.

The glass phase 302 is selected to provide and maintain an effective seal with a SOFC (not shown) during all possible operating conditions of the SOFC. The glass phase 302 is a self healing glass that does not crystallize or devitrify over time and has sufficiently low viscosity and surface tension characteristics that if it cracks on thermal cycling the crack heals at operating temperature. The reinforcing secondary or second phase 304 is, for example, a crystalline ceramic, such as zirconia with 3% yttria. A metal might also be used with modification to form the reinforcing secondary or second phase 304, particularly for other applications for high temperature seals than a SOFC.

The core 306 is a hollow core, for example, filled with an inert gas or air, analogous to an automotive tire providing a degree of compressibility to this seal structure 300. Alternatively the core 306 is filled with a selected material, for example, to provide a more specific degree of compressibility and strength, such as a lower melting point glass.

The glass phase 302 and the crystalline ceramic phase 304 of the compressive composite seal structure 300 are shaped, for example, as a multi-layer tape wrap and multiple multi-layer tapes are wrapped around a combustible filament having a control core diameter for compressive core 306 to form the composite seal structure 300. Alternatively, multiple dip coatings of a combustible filament having a control core diameter for compressive core 306 forms each layer of the glass phase 302 and the crystalline ceramic phase 304 of the compressive composite seal structure 300. With the compressive composite seal structure 300, it is more difficult to control thicknesses as precisely as with the compressive composite seal structure 100.

The compressive composite seal structure 300 maintains an effective seal with the glass phase 302 provided in a multi-layer tape casting with the second phase 304 that substantially allows the glass to effectively heal if a crack occurred during thermal cycling, providing containment of the glass phase 302 with the reinforcing secondary phase 304. The reinforcing secondary phase 304 provides multi-layer protection, reducing crack propagation and providing mechanical support for the glass phase 302. The compressive composite seal structure 300 maintains an effective seal if the temperature or pressure goes too high, the seal remains in place and effective.

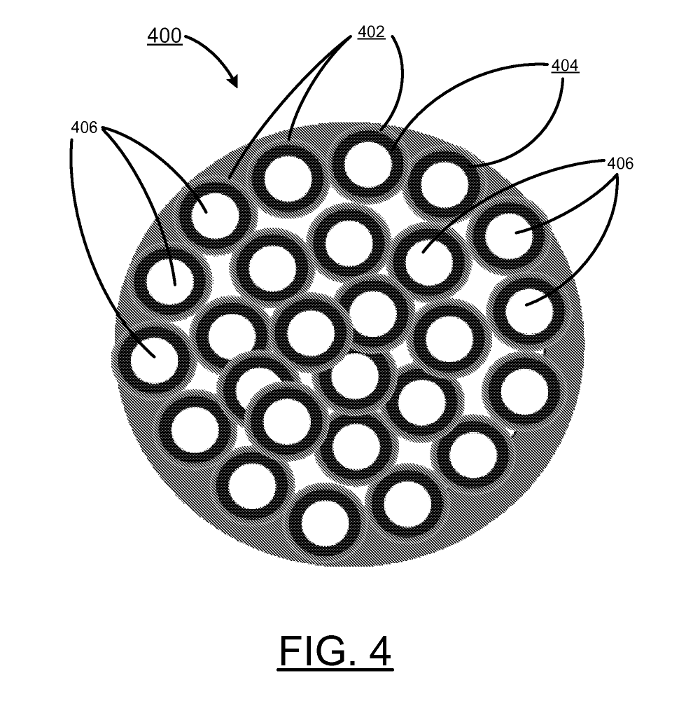

Referring now to FIG. 4, there is shown a composite seal structure generally designated by the reference character 400 in accordance with the preferred embodiment. Composite seal structure 400 is a braided compressive composite seal structure including a braided arrangement for a plurality of a glass phase generally designated by the reference character 402 together with an associated reinforcing secondary phase generally designated by the reference character 404 and a core 406.

The braided glass phase 402 is selected to provide and maintain an effective seal with a SOFC (not shown) during all possible operating conditions of the SOFC. The braided glass phase 402 is a self healing glass that does not crystallize or devitrify over time and has sufficiently low viscosity and surface tension characteristics that if it cracks on thermal cycling the crack heals at operating temperature. The braided reinforcing secondary or second phase 404 is, for example, a crystalline ceramic, such as zirconia with 3% yttria. A metal might also be used with modification to form the braided reinforcing secondary or second phase 404, particularly for other applications for high temperature seals than a SOFC.

The core 406 is a hollow core, for example, filled with an inert gas or air, analogous to an automotive tire providing a degree of compressibility to this seal structure 400. Alternatively the core 406 is filled with a selected material, for example, to provide a more specific degree of compressibility and strength, such as a lower melting point glass.

Each braided glass phase 402 and braided crystalline ceramic phase 404 of the braided compressive composite seal structure 400 are shaped, for example, as a tape and each tape is wrapped or rolled around a combustible filament having a control core diameter or compressive core 406. Alternatively, a dip coating of a combustible filament having a control core diameter for compressive core 406 forms each of the braided glass phase 402 and the braided crystalline ceramic phase 404 of the braided compressive composite seal structure 400. With the braided compressive composite seal structure 400, it is more difficult to control thicknesses as precisely as with the compressive composite seal structure 100.

The braided compressive composite seal structure 400 maintains an effective seal with each glass phase 402 provided with the second phase 404 that substantially allows the glass to effectively heal if a crack occurred during thermal cycling, providing containment of the glass phase 402 with the reinforcing secondary phase 404. Each reinforcing secondary phase 404 reduces crack propagation and provides mechanical support for the glass phase 402. The braided compressive composite seal structure 400 maintains an effective seal if the temperature or pressure goes too high, the seal remains in place and effective.

While the present invention has been described with reference to the details of the embodiments of the invention shown in the drawing, these details are not intended to limit the scope of the invention as claimed in the appended claims.

What is claimed is:

1. A compressive composite seal structure for high temperature sealing applications comprising:
a glass phase for providing a gas tight seal;
a reinforcing secondary phase for providing mechanical stability for said glass phase; and
a compressive core surrounded by said reinforcing secondary phase and said glass phase.

2. The compressive composite seal structure as recited in claim 1 wherein said glass phase is selectively provided for sealing a solid oxide fuel cell (SOFC) component.

3. The compressive composite seal structure as recited in claim 2 wherein the compressive composite seal structure maintains an effective seal during each operating condition of the SOFC.

4. The compressive composite seal structure as recited in claim 1 wherein said glass phase is supported by said reinforcing secondary phase.

5. The compressive composite seal structure as recited in claim 1 wherein said reinforcing secondary phase effectively reduces crack propagation and provides mechanical support for said glass phase.

6. The compressive composite seal structure as recited in claim 1 wherein said reinforcing secondary phase is a crystalline ceramic.

7. The compressive composite seal structure as recited in claim 1 wherein said reinforcing secondary phase is formed of zirconia with 3% yttria.

8. The compressive composite seal structure as recited in claim 1 wherein said reinforcing secondary phase is formed of a modified metal.

9. The compressive composite seal structure as recited in claim 1 wherein said compressive core selectively provides a degree of compressibility to the compressive composite seal structure.

10. The compressive composite seal structure as recited in claim 1 wherein said compressive core is filled with an inert gas.

11. The compressive composite seal structure as recited in claim 1 wherein said compressive core is filled with air.

12. The compressive composite seal structure as recited in claim 1 wherein said compressive core is filled with a selected material for providing a degree of compressibility and strength.

13. The compressive composite seal structure as recited in claim 1 wherein said compressive core is filled a selected glass having a lower melting point than said glass phase.

14. The compressive composite seal structure as recited in claim 1 wherein said reinforcing secondary phase and said glass phase are formed of selected materials having different thermal expansion coefficients.

15. The compressive composite seal structure as recited in claim 1 wherein said reinforcing secondary phase and said glass phase include a multiple layer spiral arrangement.

16. The compressive composite seal structure as recited in claim 1 wherein said reinforcing secondary phase and said glass phase include a single layer arrangement.

17. The compressive composite seal structure as recited in claim 1 wherein said reinforcing secondary phase and said glass phase include a multiple layer arrangement.

18. The compressive composite seal structure as recited in claim 1 wherein said reinforcing secondary phase and said glass phase include a multiple braided arrangement.

19. The compressive composite seal structure as recited in claim 1 wherein said glass phase includes a self healing glass.
